(19) United States
(12) Patent Application Publication
(10) Pub. No.: US 2016/0358599 A1
(43) Pub. Date: Dec. 8, 2016

(54) SPEECH ENHANCEMENT METHOD, SPEECH RECOGNITION METHOD, CLUSTERING METHOD AND DEVICE

(71) Applicant: LE SHI ZHI XIN ELECTRONIC TECHNOLOGY (TIANJIN) LIMITED, Beijing (CN)

(72) Inventor: Yujun WANG, Beijing (CN)

(73) Assignee: LE SHI ZHI XIN ELECTRONIC TECHNOLOGY (TIANJIN) LIMITED, Beijing (CN)

(21) Appl. No.: 15/173,579

(22) Filed: Jun. 3, 2016

(30) Foreign Application Priority Data
Jun. 3, 2015 (CN) 201510303746.4

(51) Int. Cl. G10L 15/06; G10L 15/02; G10L 15/10

(52) U.S. Cl. CPC G10L 15/063; G10L 15/10; G10L 15/02; G10L 2015/0633

(57) ABSTRACT

The present invention discloses a speech enhancement method, a speech recognition method, a clustering method and a device. The method includes: selecting a feature vector clustering center best matched with the feature vector of a first frame speech part of a test speech; performing direct to the feature vectors of other frame speech parts contained in the test speech: selecting a feature vector clustering center best matched with the feature vector of the speech part from a feature vector clustering center best matched with the feature vector of a previous frame speech part to the speech part and a feature vector clustering center adjacent to the feature vector clustering center best matched with the feature vector of the previous frame speech part; and reconstructing the feature vector of the test speech according to the feature vectors of each frame speech part contained in the test speech and the selected feature vector clustering center. Because a feature capable of representing speech continuity is utilized during speech enhancement, the present invention can achieve a better speech enhancement effect relative to a traditional speech enhancement model in the prior art.

### TECHNICAL FIELD

The present invention relates to the field of computer technologies, and more particularly, to a speech enhancement method, a speech recognition method, a clustering method, a speech enhancement device, a speech recognition device, a clustering device, a speech enhancement apparatus, a speech recognition apparatus and a clustering apparatus.

### BACKGROUND

Speech recognition is also called as automatic speech recognition (ASR), speech identification or language identification, which aims at converting vocabulary contents in a speech signal into computer-readable inputs, for example, keys, binary encoding or character sequences and the like.

During practical application, the speech signal (generally called as test speech) as a speech recognition target is doped with various noises usually, which directly causes a lower recognition rate on such a speech signal. In view of this situation, a speech enhancement operation will be performed usually before recognizing the speech signal.

The speech enhancement refers to a technology which extracts useful speech signal from noise background after the speech signal is interfered and even submerged by various noises, to suppress and reduce the noise interference.

In the prior art, a common speech enhancement solution is as follows: using a sample speech (also called as training corpus) to establish a traditional speech enhancement model; and using the traditional speech enhancement model to perform speech enhancement on the test speech. The solution has the defects that it is difficult to achieve a better speech enhancement effect in the case that the best matching rate between the test speech and the training corpus is lower, so that the speech recognition rate is lower.

### SUMMARY

The embodiments of the present invention provide a speech enhancement method, a speech enhancement method, a clustering method, a speech enhancement device, a speech recognition device, a clustering device, a speech enhancement apparatus, a speech recognition apparatus and a clustering apparatus, which are used to solve the problem that a better speech enhancement effect cannot be achieved by using a traditional speech enhancement model.

The embodiments of the present invention provide a speech enhancement method, including:

selecting a feature vector clustering center best matched with the feature vector of a first frame speech part contained in a test speech from feature vector clustering centers obtained by training;

performing direct to the feature vectors of other frame speech parts contained in the test speech: selecting a feature vector clustering center best matched with the feature vector of the speech part from a feature vector clustering center best matched with the feature vector of a previous frame speech part to the speech part and obtained by training and a feature vector clustering center adjacent to the feature vector clustering center best matched with the feature vector of the previous frame speech part, wherein a set formed by each of the feature vector clustering centers obtained by training and one adjacent feature vector clustering center thereof has an ability to describe speech continuity; and

reconstructing the feature vector of the test speech according to the feature vectors of each frame speech part contained in the test speech and the selected feature vector clustering center.

The embodiments of the present invention also provide a speech recognition method, including the step of performing speech recognition on a speech signal reconstructed by using the foregoing speech enhancement method.

The embodiments of the present invention also provide a clustering method, including:

respectively extracting feature vector samples from each frame speech part contained in a training corpus;

determining the distribution information of the feature vector samples in a multidimensional space;

determining initial clustering centers according to the distribution information;

performing iterative clustering on each initial clustering center to obtain undetermined clustering centers according to the similarity between the feature vector samples and each initial clustering center; and

performing iterative clustering on the undetermined clustering centers to obtain a feature vector clustering center according to the feature vectors of adjacent speech parts in the training corpus.

The embodiments of the present invention also provide a speech enhancement device, including: a selection unit configured to select a feature vector clustering center best matched with the feature vector of a first frame speech part contained in a test speech from feature vector clustering centers obtained by training; and, perform direct to the feature vectors of other frame speech parts contained in the test speech: selecting a feature vector clustering center best matched with the feature vector of the speech part from a feature vector clustering center best matched with the feature vector of a previous frame speech part to the speech part and obtained by training and a feature vector clustering center adjacent to the feature vector clustering center best matched with the feature vector of the previous frame speech part, wherein a set formed by each of the feature vector clustering centers obtained by training and one adjacent feature vector clustering center thereof has an ability to describe speech continuity; and a reconstruction unit configured to reconstruct the feature vector of the test speech according to the feature vectors of each frame speech part contained in the test speech and the selected feature vector clustering center selected by the selection unit.

The embodiments of the present invention also provide a speech recognition device, including: a speech recognition unit configured to perform speech recognition on a speech signal reconstructed by using the foregoing speech enhancement device.

The embodiments of the present invention also provide a clustering device, including: a feature extraction unit configured to respectively extract feature vector samples from each frame speech part contained in a training corpus; a distribution determination unit configured to determine the distribution information of the feature vector samples in a multidimensional space; an initial clustering center determination unit configured to determine initial clustering centers according to the distribution information; a first clustering unit configured to perform iterative clustering on each initial clustering center to obtain undetermined clustering centers according to the similarity between the feature vector samples and each initial clustering center; and a second clustering unit configured to perform iterative clustering on the undetermined clustering centers obtained by the first clustering unit to obtain a feature vector clustering center according to the feature vectors of adjacent speech parts in the training corpus.

According to the speech enhancement method, the speech recognition method, the clustering method and the device provided by the embodiments of the present invention, the adjacent feature vector clustering center for the feature vectors of other frame speech parts excluding the first frame contained in the test speech is determined from the feature vector clustering center adjacent to the feature vector of the previous frame speech part to the speech part and the feature vector clustering center adjacent to the adjacent feature vector clustering center to the feature vector of the previous frame speech part to the speech part, while the set formed by each of the feature vector clustering centers obtained by training and at least one adjacent feature vector clustering center thereof has the ability to describe speech continuity, which is equivalent to utilize a feature capable of representing speech continuity for performing speech enhancement; therefore, the invention achieves a better speech enhancement effect relative to the traditional speech enhancement model in the prior art.

### BRIEF DESCRIPTION OF THE DRAWINGS

In order to explain the technical solutions in the embodiments of the invention or in the prior art more clearly, the drawings used in the descriptions of the embodiments or the related art will be simply introduced hereinafter. It is apparent that the drawings described hereinafter are merely some embodiments of the invention, and those skilled in the art may also obtain other drawings according to these drawings without going through creative work.

FIG. 1a is a schematic flow diagram of a speech enhancement method provided by a first embodiment of the present invention;

FIG. 1b is a schematic distribution diagram of feature vector samples in a multidimensional space;

FIG. 1c is a schematic diagram of a self-organizing map generated in the first embodiment of the present invention;

FIG. 1d is a schematic diagram of a self-organizing map including an initial clustering center generated in the first embodiment of the present invention;

FIG. 1e is a schematic diagram of a relationship between an initial clustering center and an adjacent initial clustering center;

FIG. 2a is a structure diagram of a speech recognition system adopted in a second embodiment of the present invention;

FIG. 2b is a schematic diagram of an implementation manner for functions of a training subsystem in the second embodiment of the present invention;

FIG. 3 is a structure diagram of a speech enhancement device provided by a third embodiment of the present invention; and

FIG. 4 is a structure diagram of a clustering device provided by a fourth embodiment of the present invention.

FIG. 5 is a structure diagram of a speech enhancement apparatus provided by a fifth embodiment of the present invention.

FIG. 6 is a structure diagram of a speech recognition apparatus provided by a sixth embodiment of the present invention.

FIG. 7 is a structure diagram of a clustering device provided by a seventh embodiment of the present invention.

### DETAILED DESCRIPTION

To make the objects, technical solutions and advantages of the embodiments of the present invention more clearly, the technical solutions of the present invention will be clearly and completely described hereinafter with reference to the embodiments and corresponding drawings of the present invention. Apparently, the embodiments described are merely partial embodiments of the present invention, rather than all embodiments. Other embodiments derive by those having ordinary skills in the art on the basis of the embodiments of the invention without going through creative efforts shall all fall within the protection scope of the present invention.

The technical solutions provided by each embodiment of the present invention will be described in details with reference to the drawings hereinafter.

### First Embodiment

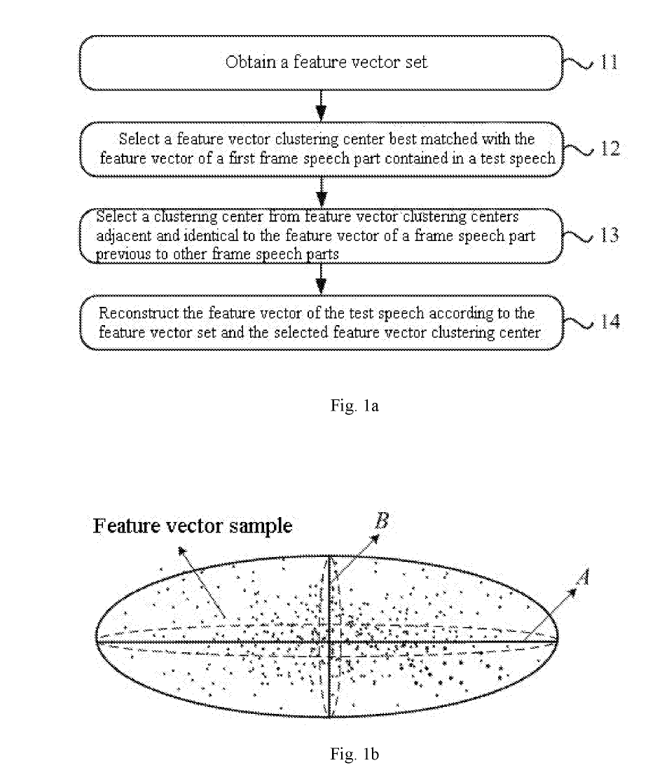

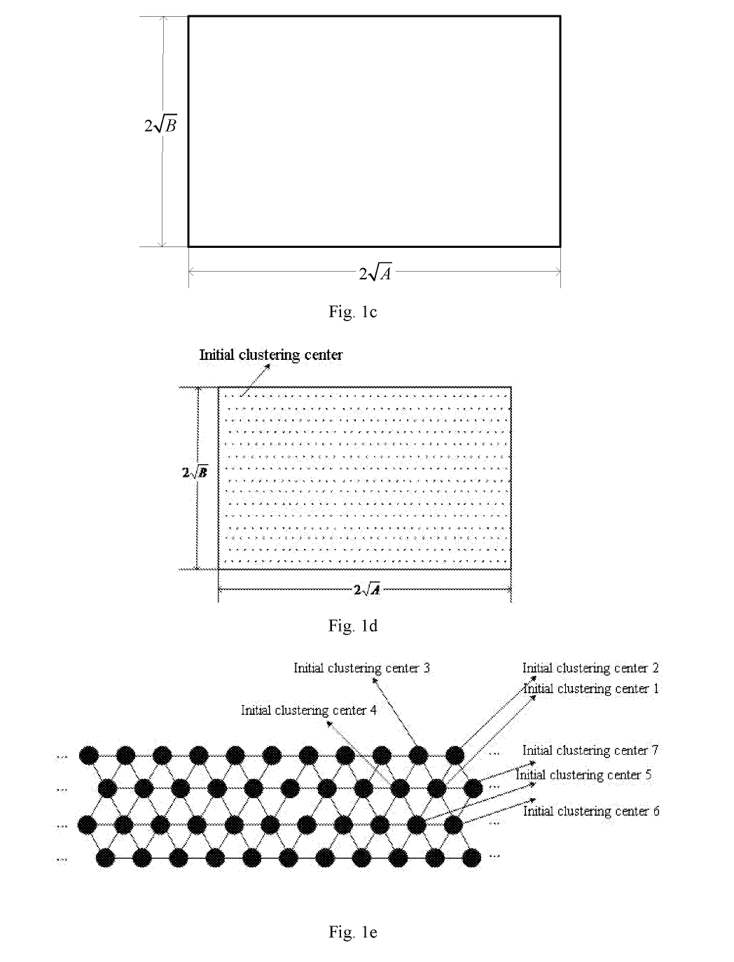

In order to achieve a better speech enhancement effect, the first embodiment of the present invention provides a speech enhancement method. The implementation schematic flow diagram of the method which is as shown in FIG. 1a, includes the following steps.

In step 11, a feature vector set is obtained.

Wherein, the feature vector set mentioned herein is formed by feature vectors extracted out from a test speech.

In the embodiment of the present invention, the feature vector may be a vector extracted from the test speech and associated with speech recognition, and may particularly be any feature vector capable of representing a sound track shape. For instance, a frequency spectrum feature vector is just a feature vector capable of representing the sound track shape.

To be specific, the frequency spectrum feature vector may be a frequency spectrum feature vector like a feature vector formed by Mel Frequency Cepstrum Coefficients (MFCC), or the like.

The dimensions of the feature vector are not defined in the embodiment of the present invention, which may either be 12 dimensions or 40 dimensions, and the like.

In step 12, a feature vector clustering center best matched with the feature vector of a first frame speech part contained in a test speech is selected from feature vector clustering centers obtained by training.

In the embodiment of the present invention, the feature vector best matched with the feature vector clustering center means that the value of the similarity between the feature vector and the feature vector clustering center is less than a similarity threshold. Generally, the similarity between the feature vector and the feature vector clustering center may be weighed by the Euclid distance between the feature vector and the feature vector clustering center. The smaller the distance is, the larger the value of the similarity is. Otherwise, the value of the similarity is smaller.

The similarity threshold usually determines the quantity of the feature vector clustering centers best matched with the feature vector of the first frame speech part contained in the test speech. Generally, the smaller the threshold is, the fewer the quantity is. Otherwise, the quantity is larger. The specific threshold is not defined in the embodiment of the present invention.

In the embodiment of the present invention, a training corpus can be collected in advance and trained in order to select the feature vector best matched with the test speech and as a basis for performing speech enhancement on the test speech. The training process generally includes: extracting feature vectors from the training corpus; clustering the feature vectors extracted according to a given clustering manner and generating a feature vector clustering center.

In the embodiment of the present invention, the following substeps may be adopted to generate the feature vector clustering center in order to ensure that the feature vector clustering centers adjacent to each other among the feature vector clustering centers used have continuity when performing speech enhancement operation on the test speech.

In substep I, feature vector samples are respectively extracted from each frame speech part contained in a training corpus.

In substep II, the distribution information of the feature vector samples in a multidimensional space is determined.

To be specific, the multidimensional space including each feature vector sample may be generated according to the feature vector samples and the dimensions of the feature vector samples. In the multidimensional space, each feature vector sample may exist as a point in the space, which is as shown in FIG. 1b. The distribution information of the feature vector samples in the multidimensional space can be determined according to the distribution situation of each point in the multidimensional space. For instance, take FIG. 1b for example. The distribution information specifically refers to a maximum feature value A and a second largest feature value B of an autocorrelation matrix of the feature vector sample.

In substep III, initial clustering centers are determined according to the distribution information.

Take the distribution information A and B as shown in FIG. 1b for example, 2\sqrt{A} can be used as the length of a horizontal segment in a two-dimensional space, and 2\sqrt{B} may be used as the length of a vertical segment in the two-dimensional space, to generate a self-organizing map as shown in FIG. 1c.

Further, the self-organizing map including initial clustering centers as shown in FIG. 1d may be generated according to a principle of “making the initial clustering centers to be evenly distributed in a rectangular frame in the self-organizing map” and the quantity of the initial clustering centers set in advance. The quantity of the initial clustering centers are not defined in the embodiment of the present invention, for instance, the quantity may either be 10 thousands or 20 thousands, and the like.

Those skilled in the art may understand that other principles different from the foregoing principle may also be followed up when generating the self-organizing map including the initial clustering center in the embodiment of the present invention. For instance, other principle may be “making 80% initial clustering centers be evenly distributed in a frame (which will not be a rectangle frame) in the self-organizing map”; or “making 50% initial clustering center be evenly distributed in a specific region in a frame in the self-organizing map”, or the like. Furthermore, the specific space in the embodiment of the present invention may either be a two-dimensional space, a third-dimensional space, a four-dimensional space, or the like.

It should be illustrated that although the initial clustering center can be presented as a point on the two-dimensional self-organizing map, the dimensions of each initial clustering center are still identical to the dimensions of the feature vector samples; that is, each initial clustering center can still be represented by a vector in the multidimensional space which takes the dimensions as spatial dimension. To facilitate description, it is provided that both the dimensions of the initial clustering centers and the feature vector samples in the embodiment of the present invention are M.

In the embodiment of the present invention, all the clustering centers on the self-organizing map (no matter initial clustering centers or other clustering centers introduced hereinafter) can be deemed as “neurons” in a single-layer neural network.

In substep IV, iterative clustering is performed on each initial clustering center to obtain undetermined clustering centers according to the similarity between the feature vector samples and each initial clustering center.

The specific implementation manner of substep IV is introduced by taking the case of using the feature vector samples extracted from the training corpus to perform one iterative clustering on each initial clustering center as an example.

Firstly, initial clustering centers best matched with the feature vector sample of each frame speech part of the training corpus are respectively determined, and initial clustering centers adjacent to the best matched initial clustering centers are determined from the initial clustering centers. Please refer to FIG. 1e. If an initial clustering center best matched with a feature vector sample of a certain speech part is initial clustering center 1, then the initial clustering centers adjacent to the initial clustering center 1 are initial clustering center 2 to initial clustering center 7.

Then, the parameter value of each initial clustering center is calculated according to the similarity between the feature vector sample of each frame speech part and the initial clustering center best matched thereof respectively as well as the similarity between the feature vector sample of each frame speech part and the initial clustering center adjacent to the best matched initial clustering center thereof. In the self-organizing map, the clustering center (for example, initial clustering center) best matched with the feature vector sample of a single-frame speech part can be called as best matched unit (BMU).

To be specific, the similarity between the feature vector sample of the single-frame speech part and the best matched initial clustering center (i.e., BMU) thereof may be equal to 1, while the similarity between the feature vector sample and the initial clustering center adjacent to the BMU can be calculated by using a gaussian attenuation manner. In the embodiment of the present invention, the calculating the similarity between the feature vector sample and the initial clustering center adjacent to the BMU using a gaussian attenuation manner may refer to calculating the similarity using the following formula:

$$p ( {x}_{i} ) = exp ( - \frac{{x}_{i}^{2}}{2} )$$

Wherein, i is the numbering of the initial clustering center adjacent to the BMU; xᵢ is the Euclid distance between the adjacent initial clustering center with a numbering of i and the BMU; and r is a learning rate, which is a constant, and can be set according to actual demands.

The similarity calculated using a gaussian attenuation manner can be specifically used to represent “a proportion value of the feature vector sample of the frame speech part distributed to a certain adjacent initial clustering center”, i.e., represent “the posteriori probability value of the feature vector sample of the frame speech part attributed to a certain adjacent initial clustering center”. The more adjacent the initial clustering center to the BMU of the feature vector sample is (i.e., the neuron closer to the BUM in the self-organizing map), the larger the proportion value of be distributed to the feature vector sample is. Otherwise, the proportion value is smaller.

For instance, if the following assumption is workable:

the similarity between five feature vector samples and a certain initial clustering center is not equal to 0;

the posteriori probability values of the five feature vector samples attributed to the initial clustering center are respectively 1, 1, 0.2, 0.5, and 0.1;

the five feature vector samples are respectively {x₁, y₁,z₁,m₁,n₁}, {x₂, y₂,z₂,m₂,n₂}, {x₃, y₃,z₃,m₃,n₃}, {x₄, y₄,z₄,m₄,n₄} and {x₅, y₅,z₅,m₅,n₅}.

Then, the parameter value of the initial clustering center is: the posteriori probability value of each feature vector sample attributed to the initial clustering center and the weighted average value of each feature vector sample. It is knowable according to the above description that the “posteriori probability value of each feature vector sample attributed to the initial clustering center” mentioned herein is namely the similarity between each feature vector sample and the initial clustering center.

That is, the parameter value of the initial clustering center=[1×{x₁,y₁,z₁,m₁,n₁}+1×{x₂, y₂,z₂,m₂,n₂}+0.2×{x₃,y₃,z₃,m₃,n₃}+0.5×{x₄,y₄,z₄,m₄,n₄}+0.1×{x₅,y₅,z₅,m₅,n₅}]/(1+1+0.2+0.5+0.1).

According to the foregoing manner, the calculation of the parameter value of each initial clustering center may be completed. After the calculation of the parameter value of each initial clustering center is completed, single iterative clustering is completed.

In the embodiment of the present invention, the foregoing iterative clustering operation may be repeatedly performed until a first iterative convergence condition is satisfied, and each initial clustering center having the parameter value calculated when the first iterative convergence condition is satisfied is determined as “undetermined clustering centers”.

To be specific, the iterative convergence condition, for example, may be: the amplitudes of variation of the parameter values of each initial clustering center obtained after completing current iterative clustering operation relative to the parameter values of each initial clustering center obtained after last iterative clustering operation are all less than a stipulated threshold; or the amplitudes of variation of 80% of the parameter values of each initial clustering center obtained after completing current iterative clustering operation relative to the corresponding parameter values obtained after last iterative clustering operation are less than the stipulated threshold, and the like.

For the above descriptions, it should be illustrated that all the speeches (both the training corpus and the test speech are speeches) can be divided into multi-frame speech parts, wherein each frame speech part can be called as one frame speech part. Each frame speech part can be numbered respectively according to the arrangement positions of each frame speech part in the speech. Wherein, the speech part arranged in the foremost is the part in the speech which is heard firstly, which can be distributed with a numbering “1”, i.e., the speech part is the first frame speech part of the speech; The other speech parts can be distributed with numbering “2”, “3” . . . “N”, according to the sequence of the positions thereof in the speech. N is the total frame number of the speech part contained in the speech. Furthermore, it should be illustrated that the similarity between the initial clustering center and the feature vector sample can be weighed by the Euclid distance between the initial clustering center and the feature vector sample. The larger the distance is, the larger the similarity is. Otherwise, the similarity is smaller. In the embodiment of the present invention, the value range of the similarity may be [0, 1].

In sub step V, iterative clustering is performed on undetermined clustering centers according to given iterative clustering rules to obtain a feature vector clustering center.

Wherein, the given iterative clustering rules mentioned herein include: 1. performing iterative clustering on the undetermined clustering centers according to the feature vectors of each speech part of the training corpus; 2. the feature vector pursuant when performing single iterative clustering on the undetermined clustering centers being the feature vector of single speech part in the training corpus; and 3. the feature vectors respectively pursuant when performing every two adjacent iterative clustering on the undetermined clustering centers being the feature vectors of adjacent speech parts in the training corpus.

In an implementation manner, the implementation process of the substep V is as follows:

iterative clustering operation direct to each training corpus is performed according to the given iterative clustering rules, and when a second iterative convergence condition is satisfied, each undetermined clustering center having the parameter value calculated when the second iterative convergence condition is satisfied is determined as the feature vector clustering center.

Wherein, the iterative clustering operation mentioned herein includes the following steps:

determining the similarity between the feature vector of the first frame speech part of the training corpus and the undetermined clustering center best matched with the feature vector of the first frame speech part, and the similarity between the feature vector of the first frame speech part and the undetermined clustering center adjacent to the best matched undetermined clustering center;

moreover, performing direct to other frame speech parts of the training corpus: determining the undetermined clustering center best matched with the speech part, and determining the similarity between the feature vector of the speech part and the best matched undetermined clustering center and the similarity between the feature vector of the speech part and the undetermined clustering center adjacent to the best matched undetermined clustering center from the undetermined clustering center best matched with the feature vector of the previous frame speech part adjacent to the speech part and the clustering center adjacent to the undetermined clustering center best matched with the feature vector of the previous frame speech part adjacent to the speech part in the self-organizing map; and

finally, calculating the parameter values of each undetermined clustering center according to each similarity determined. The specific calculation method is similar to the calculation method in substep IV, and will not be elaborated herein.

The foregoing second iterative convergence condition is similar to the contents of the first iterative convergence condition, which, for example, may be: the amplitudes of variation of the parameter values of each undetermined clustering center obtained after completing current iterative clustering operation relative to the parameter values of each undetermined clustering center obtained after last iterative clustering operation are all less than a stipulated threshold; or the amplitudes of variation of 80% of the parameter values of each undetermined clustering centers obtained after completing current iterative clustering operation relative to the corresponding parameter values obtained after last iterative clustering operation are less than the stipulated threshold, and the like.

By comparing the differences between the substep IV and the substep V, it is knowable that in the sub step V, the undetermined clustering centers best matched with other frame speech parts excluding the first frame of the training corpus is determined from the undetermined clustering centers best matched with the feature vector of previous speech part adjacent to each frame speech part and the clustering center adjacent to the undetermined clustering center best matched with the feature vector of the previous frame speech part adjacent to the speech part in the self-organizing map. This manner has the advantage of enabling a set (for example, self-organizing map) formed of the feature vector clustering centers to have an ability of describing speech continuity. The speech continuity mentioned herein is a conclusion obtained after analyzing a number of speeches. The conclusion is particularly as follows: in a section of speech, the two adjacent frame speech parts have a certain similarity, i.e., the feature vector of a first frame speech part of the speech and the feature vector of a second frame speech part are usually similar; and the feature vector of the second frame speech part of the speech and the feature vector of a third frame speech part are usually similar; and so on.

In step 13, the following is performed direct to the feature vectors of other frame speech parts contained in the test speech: selecting a feature vector clustering center best matched with the feature vector of the speech part from a feature vector clustering center best matched with the feature vector of a previous frame speech part to the speech part and obtained by training and a feature vector clustering center adjacent to the feature vector clustering center best matched with the feature vector of the previous frame speech part,

The “other frame speech parts contained in the test speech” mentioned herein refers to other speech parts contained in the test speech excluding the first frame speech part.

The specific implementation manner of step 13 is illustrated as follows:

for instance, with respect to the feature vector of the second frame speech part contained in the test speech, a feature vector clustering center best matched with the feature vector of the second frame speech part is selected from the feature vector clustering center best matched with the feature vector of the first frame speech part selected and the feature vector clustering center adjacent to the feature vector clustering center best matched with the feature vector of the first frame speech part selected; with respect to the feature vector of the third frame speech part contained in the test speech, a feature vector clustering center best matched with the feature vector of the third frame speech part is selected from the feature vector clustering center best matched with the feature vector of the second frame speech part selected and the feature vector clustering center adjacent to the feature vector clustering center best matched with the feature vector of the second frame speech part selected, and so on.

It is knowable from the explanation on step 12 mentioned above the clustering method for generating the feature vector clustering center provided by the present invention may enable a set formed by the feature vector clustering centers obtained finally to have an ability of describing speech continuity because the iterative clustering performed on adjacent undetermined clustering centers is based on the feature vectors of two adjacent frame speech parts. Based on such a set, adopting the selection way in step 13 of the embodiment of the present invention may enable the selected feature vector clustering centers to continue the ability of describing speech continuity, so as to reconstruct the feature vector of the test speech according to the selected feature vector clustering centers; therefore, a better enhancement effect can be obtained.

In step 14, the feature vector of the test speech is reconstructed according to a feature vector set and the selected feature vector clustering center.

In an implementation manner, the feature vector of the test speech may be reconstructed using but not limited to an interpolation operation manner. That is, the interpolation operation on the feature vector set is performed according to the selected feature vector clustering center, so as to obtain the reconstructed feature vector of the test speech.

According to the foregoing method provided by the embodiment of the present invention, the adjacent feature vector clustering center for the feature vectors of other frame speech parts excluding the first frame included in the test speech is determined from the feature vector clustering center adjacent to the feature vector of the previous frame speech part to the speech part and the feature vector clustering center adjacent to the adjacent feature vector clustering center to the feature vector of the previous frame speech part to the speech part, while the set formed by each of the feature vector clustering centers obtained by training and at least one adjacent feature vector clustering center thereof has the ability to describe speech continuity, which is equivalent to utilize a feature capable of representing speech continuity for performing speech enhancement; therefore, the invention achieves a better speech enhancement effect relative to the traditional speech enhancement model in the prior art.

After the reconstructed feature vector of the test speech is obtained through the foregoing method, the feature vector may be inputted into a speech recognition device to implement speech recognition of the test speech. The adjacent feature vector clustering center for the feature vectors of other frame speech parts excluding the first frame included in the test speech is determined from the feature vector clustering center adjacent to the feature vector of the previous frame speech part to the speech part and the feature vector clustering center adjacent to the adjacent feature vector clustering center to the feature vector of the previous frame speech part to the speech part, while the set formed by each of the feature vector clustering centers obtained by training and at least one adjacent feature vector clustering center thereof has the ability to describe speech continuity, which is equivalent to utilize a feature capable of representing speech continuity for performing speech enhancement; therefore, the invention achieves a better speech enhancement effect relative to the traditional speech enhancement model in the prior art, and the recognition rate of the speech recognition can be improved.

It should be illustrated that all the executive bodies of each step of the method provided by the first embodiment can be the same device, or different devices may also be used in the method as the executive bodies. For instance, the executive body of step 11 and step 12 may be device 1, and the executive body of step 13 and step 14 may be device 2. For another instance, the executive body of step 11 may be device 1, and the executive body of step 12 to 14 may be device 2, etc.

### Second Embodiment

In the second embodiment of the present invention, the practical application of the speech enhancement method provided by the first embodiment of the present invention in a speech recognition process is mainly introduced.

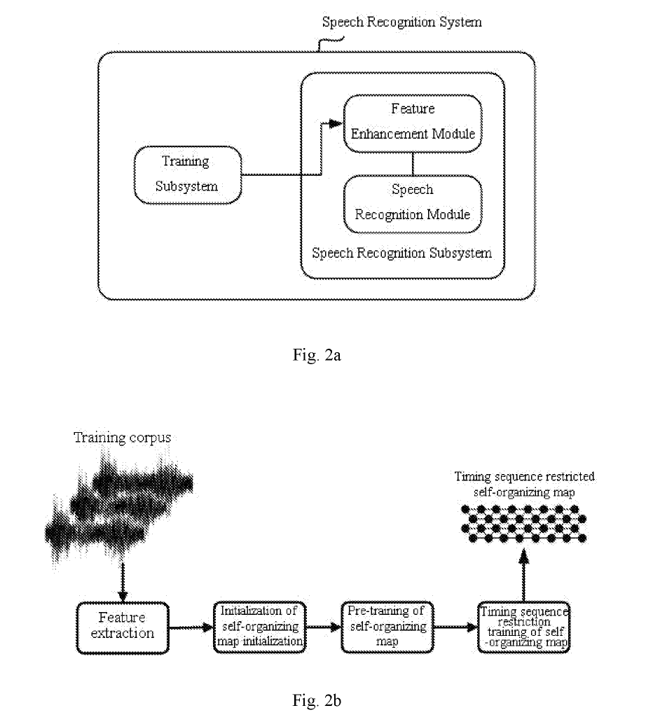

To be specific, the structure diagram of a speech recognition system configured to implement the method in practice is as shown in FIG. 2a, which mainly includes a training subsystem and a speech recognition subsystem. Wherein, the training subsystem is configured to generate the self-organizing map mentioned above; while the speech recognition subsystem is configured to recognize the test speech on the basis of the self-organizing map generated by the training subsystem.

The implementation manners of the functions of the foregoing two subsystems are respectively introduced hereinafter.

1. Training Subsystem

The function of the training subsystem is to generate a timing sequence restricted self-organizing map. The implementation manner of the function mainly includes the following steps as shown in FIG. 2b.

In Step I, features are extracted.

That is, feature vectors (i.e., the feature vector samples mentioned above) are extracted from a training corpus.

In step II, the self-organizing map is initialized.

To be specific, a corresponding covariance matrix may be calculated according to all the feature vector samples extracted. Then, after principal component analysis is performed on the covariance matrix, the double of the square root of a maximum feature value determined is taken as the width of the self-organizing map, and the double of the square root of a second largest feature value is taken as the height of the self-organizing map, and then the self-organizing map containing neurons with a given quantity is generated according to the given neuron quantity.

In the second embodiment, the self-organizing map is a single-layer neural network, and each node of the network is a neuron. The parameter value of the neuron which will be mentioned hereinafter is used to represent one mean speech feature vector. The neural network may be a hexagon topology as shown in FIG. 1e.

It should be illustrated that such pretreatment as channel normalization, diagonalizable transformation or discrimination transformation may be performed on the extracted feature vector samples in order to enhance the expression ability of the neurons on the self-organizing map, and then a corresponding covariance matrix is calculated using the feature vector samples after the pretreatment.

In step III, the self-organizing map is pre-trained.

Pre-training of the self-organizing map is the basis of the training for the timing sequence restriction of the self-organizing map. The object of the pre-training of the self-organizing map is to obtain a map capable of reflecting the distribution situation of the feature vector samples.

To be specific, the implementation manner of step III includes: performing sample distribution (step E) and neuron parameter assessment (step M) on each training corpus.

Wherein, the step E is as follows: for each feature vector sample extracted from the training corpus, respectively seeking an optimum and best matched neuron in the self-organizing map, i.e., seeking the neurons having a minimal Euclid distance with each feature vector sample respectively as the optimum and best matched neuron of the feature vector sample; and determining the proportion of distributing the feature vector sample to the corresponding optimum and best matched neuron as 1; then, for the neuron adjacent to the optimum and best matched neuron, calculating the proportion of distributing the corresponding feature vector sample to the adjacent neuron according to the gaussian attenuation manner of distance.

After step E, each neuron is distributed with the proportion of at least one feature vector sample. It should be illustrated that a case that a certain neuron is not distributed with the proportion of a certain feature vector sample may be understood as the proportion of distributing the neuron to the feature vector sample is 0.

The step M is as follows: each neuron performs weighted mean on the proportion of the feature vector sample distributed thereof to obtain the parameter value thereof.

The step E and the step M are alternatively performed; when the first iterative convergence condition according to the first embodiment is satisfied, each neuron having the parameter value calculated when the first iterative convergence condition is satisfied is determined as the neuron (i.e., the undetermined clustering center according to the first embodiment) obtained after performing pre-training on the self-organizing map.

In step IV, the time sequence restriction of the self-organizing map is trained.

The object of the training is to enable the self-organizing map to have an ability of describing speech continuity.

The implementation flow of the step IV is approximately identical to that of the step III, including a step E′ and a step M′ which are alternatively performed. When the second iterative convergence condition according to the second embodiment is satisfied, each neuron having the parameter value calculated when the second iterative convergence condition is satisfied is determined as the neuron (i.e., the undetermined clustering center according to the first embodiment) obtained after performing pre-training on the self-organizing map, so as to obtain a timing sequence restricted self-organizing map.

To be specific, the step E′ is as follows: for each feature vector sample extracted from the training corpus, respectively seeking an optimum and best matched neuron for the feature vector sample in the self-organizing map; and determining the proportion of distributing the feature vector sample to the corresponding optimum and best matched neuron as 1; then, for the neuron adjacent to the optimum and best matched neuron, calculating the proportion of distributing the corresponding feature vector sample to the adjacent neuron according to the gaussian attenuation manner of distance. To be different from the step E, in the step E′, the optimum and best matched neuron of speech feature vector xₜ₊₁ of a t+1 frame of the training corpus can be selected from the optimum and best matched neuron of speech feature vector xₜ of a t frame of the training corpus and a neuron adjacent to the optimum and best matched neuron only.

The step M′ is as follows: each neuron performs weighted mean on the proportion of the feature vector sample distributed thereof to obtain the parameter value thereof.

The function of the speech recognition subsystem is introduced hereinafter.

The speech recognition subsystem mainly includes two modules: a feature enhancement module and a speech recognition module.

Wherein, the feature enhancement module is configured to change the speech feature vector of the test speech to have the speech feature vector distribution character similar to the training corpus using the “timing sequence restricted self-organizing map” obtained by training the training corpus. The speech recognition module is configured to perform speech recognition on the speech feature vector outputted by the feature enhancement module.

In the embodiment of the present invention, the process for the feature enhancement module to perform speech feature enhancement on the test speech is just the process of searching a best speech route on the timing sequence restricted self-organizing map. Wherein, one speech route is one line (usually a curve) formed by the neurons on the timing sequence restricted self-organizing map.

To be specific, a plurality of neurons having smaller Euclid distance between the speech feature vectors extracted from the first frame speech part of the test speech are sought as the origin of multiple speech routes. Then, optimum and best matched neurons are respectively determined for the other speech parts of the test speech excluding the first frame speech part according to a manner that “the optimum and best matched neurons of an n+1 frame speech part of the test speech can be selected from the optimum and best matched neuron of an n frame speech part of the test speech and an adjacent neuron thereof only”, so as to ensure the continuity of the speech route.

The feature enhancement module after determining the optimum and best matched neurons for each frame speech part of the test speech, can obtain at least one speech route.

If only one speech route is obtained, then the speech route can be determined as the best speech route, and the parameter value of each neuron on the route and the parameter value of the neuron adjacent thereof are utilized to perform an interpolation operation on the speech feature vector of the test speech to obtain a reconstructed feature sequence and output the reconstructed feature sequence to the speech recognition module for speech recognition.

If at least two speech routes are obtained, then an optimum speech route is selected from the at least two speech routes, and then the parameter value of each neuron on the optimum speech route and the parameter value of the neuron adjacent thereof are utilized to perform an interpolation operation on the speech feature vector of the test speech to obtain a reconstructed feature sequence and output the reconstructed feature sequence to the speech recognition module for speech recognition. In the embodiment of the present invention, the optimum speech route selected satisfies: compared with other speech route obtained, the sum of the Euclidean distances (or the average Euclidean distance) between the parameter values of the neurons on the speech route and the corresponding speech feature vectors of the test speech is minimum.

It is illustrated hereinafter to how to use the parameter value of each neuron on the speech route obtained and the parameter value of the adjacent neuron thereof to perform the interpolation operation on the speech feature vector of the test speech in the embodiment of the present invention.

It is provided that the initial moment of the test speech is 0, the length of the first frame speech part of the test speech is t, and the original feature vector of the first frame speech is fₜ, then the neuron (called as neuron T hereinafter) closest to the initial neuron of the optimum route is determined from the optimum route determined for the test speech, and each neuron adjacent to the neuron T is determined.

Further, the proportion value of distributing fₜ to the neuron T and each neuron adjacent to the neuron T is calculated, and the calculated proportion value is taken as an interpolation proportion of a corresponding neuron. For instance, because fₜ is best matched with the neuron T, then the interpolation proportion of distributing fₜ to the neuron T is 1.0. If it is provided that the neuron T has six adjacent neurons, then it may be further provided that the interpolation proportion of distributing fₜ to the neuron T is 0.7.

Then, if it is provided that the interpolation proportion of all the neurons occupies 40% of an enhanced feature, then an interpolation feature fₜ′ direct to the frame speech part may be calculated according to the following formula:

fₜ′[(1−0.4)fₜ+0.4(1.0w₁+0.7w₂+0.7w₃+0.7w₄+0.7w₅+0.7w₆+0.7w₇)]/[1−0.4+0.4(1.0+0.7+0.7+0.7+0.7+0.7+0.7+0.7)]

In the foregoing formula, w₁ is the parameter value of the neuron T, w₂ to w₇ are respectively the parameter values of the six neurons adjacent to the neuron T. Each calculation method of the parameter value is as described in the first embodiment, and will not be elaborated herein.

The fₜ′ calculated is namely the enhanced feature vector of the frame speech part.

### Third Embodiment

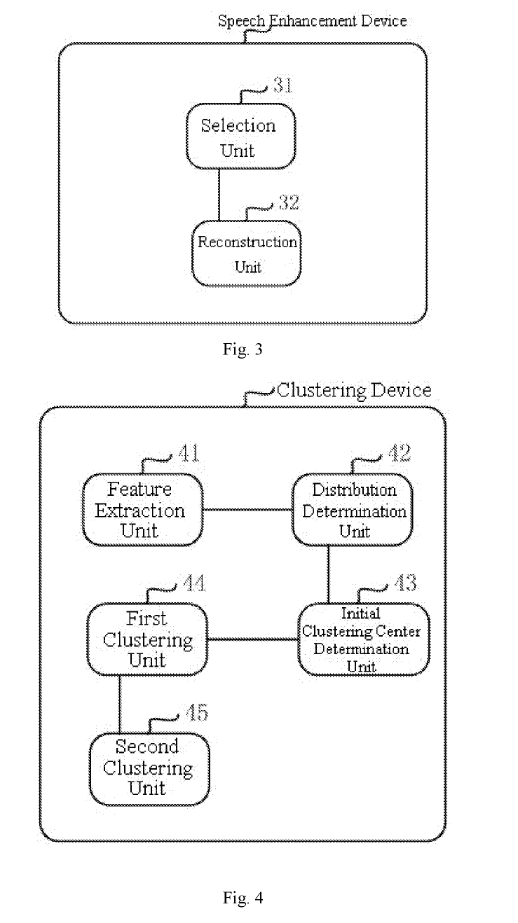

The third embodiment of the present invention provides a speech enhancement device for achieving a better speech enhancement effect. The structure diagram of the device is as shown in FIG. 3, wherein the device includes a selection unit 31 and a reconstruction unit 32. The functions of each unit are described as follows.

The selection unit 31 is configured to select a feature vector clustering center best matched with the feature vector of a first frame speech part contained in a test speech from feature vector clustering centers obtained by training; and, perform direct to the feature vectors of other frame speech parts contained in the test speech: selecting a feature vector clustering center best matched with the feature vector of the speech part from a feature vector clustering center best matched with the feature vector of a previous frame speech part to the speech part and obtained by training and a feature vector clustering center adjacent to the feature vector clustering center best matched with the feature vector of the previous frame speech part,

wherein a set formed by each of the feature vector clustering centers obtained by training and at least one adjacent feature vector clustering center thereof has an ability to describe speech continuity.

The reconstruction unit 32 is configured to reconstruct the feature vector of the test speech according to the feature vectors of each frame speech part contained in the test speech and the feature vector clustering center selected by the selection unit 31.

In an implementation manner, the reconstruction unit 32 may be specifically configured to: perform an interpolation operation on a vector set formed by the feature vectors of all the speech parts contained in the test speech according to the selected feature vector clustering center, so as to obtain the reconstructed feature vector of the test speech.

In an implementation manner, the device provided by the third embodiment of the present invention may also be configured to train the feature vector samples extracted from the training corpus. To be specific, the function can be implemented by the following units included in the device:

an extraction unit configured to respectively extract feature vector samples from each frame speech part contained in a training corpus before the selection unit 31 selects the feature vector;

a distribution determination unit configured to determine the distribution information of the feature vector samples in a multidimensional space;

an initial clustering center determination unit configured to determine initial clustering centers according to the distribution information;

a first clustering unit configured to perform iterative clustering on each initial clustering center to obtain undetermined clustering centers according to the similarity between the feature vector samples and each initial clustering center; and

a second clustering unit configured to perform iterative clustering on the undetermined clustering centers to obtain a feature vector clustering center according to the given iterative clustering rules. Wherein, the given iterative clustering rules mentioned herein include: 1. performing iterative clustering on the undetermined clustering centers according to the feature vectors of each speech part of the training corpus; 2. the feature vector pursuant when performing single iterative clustering on the undetermined clustering centers being the feature vector of single speech part in the training corpus; and 3. the feature vectors respectively pursuant when performing every two adjacent iterative clustering on the undetermined clustering centers being the feature vectors of adjacent speech parts in the training corpus.

In an implementation manner, the second clustering unit may be configured to: perform iterative clustering operation direct to each training corpus according to the given iterative clustering rules, and when an iterative convergence condition is satisfied, determine each undetermined clustering center having the parameter value calculated when the iterative convergence condition is satisfied as the feature vector clustering center.

Wherein, the iterative clustering operation includes the following steps:

determining the similarity between the feature vector of the first frame speech part of the training corpus and the undetermined clustering center best matched with the feature vector of the first frame speech part, and the similarity between the feature vector of the first frame speech part and the undetermined clustering center adjacent to the best matched undetermined clustering center;

performing direct to other frame speech parts of the training corpus: determining the undetermined clustering center best matched with the speech part, and determining the similarity between the feature vector of the speech part and the best matched undetermined clustering center and the similarity between the feature vector of the speech part and the undetermined clustering center adjacent to the best matched undetermined clustering center from the undetermined clustering center best matched with the feature vector of the previous frame speech part adjacent to the speech part and the clustering center adjacent to the undetermined clustering center best matched with the feature vector of the previous frame speech part adjacent to the speech part in the specific space; and

calculating the parameter values of each undetermined clustering center according to each similarity determined.

The adjacent feature vector clustering center for the feature vectors of other frame speech parts excluding the first frame contained in the test speech is determined from the feature vector clustering center adjacent to the feature vector of the previous frame speech part to the speech part and the feature vector clustering center adjacent to the adjacent feature vector clustering center to the feature vector of the previous frame speech part to the speech part, while the set formed by each of the feature vector clustering centers obtained by training and at least one adjacent feature vector clustering center thereof has the ability to describe speech continuity, which is equivalent to utilize a feature capable of representing speech continuity for performing speech enhancement; therefore, the invention achieves a better speech enhancement effect relative to the traditional speech enhancement model in the prior art.

### Fourth Embodiment

The fourth embodiment provides a clustering device for respectively extracting and clustering feature vector samples from each frame speech part contained in a training corpus. The structure diagram of the device is as shown in FIG. 4, wherein the device mainly includes the following function units:

a feature extraction unit 41 configured to respectively extract feature vector samples from each frame speech part contained in a training corpus;

a distribution determination unit 42 configured to determine the distribution information of the feature vector samples extracted by the feature extraction unit 41 in a multidimensional space;

an initial clustering center determination unit 43 configured to determine initial clustering centers according to the distribution information determined by the distribution determination unit 42;

a first clustering unit 44 configured to perform iterative clustering on each initial clustering center to obtain undetermined clustering centers according to the similarity between the feature vector samples and each initial clustering center; and

a second clustering unit 45 configured to perform iterative clustering on the undetermined clustering centers to obtain a feature vector clustering center according to the given iterative clustering rules.

Wherein, the given iterative clustering rules mentioned herein include: 1. performing iterative clustering on the undetermined clustering centers according to the feature vectors of each speech part of the training corpus; 2. the feature vector pursuant when performing single iterative clustering on the undetermined clustering centers being the feature vector of single speech part in the training corpus; and 3. the feature vectors respectively pursuant when performing every two adjacent iterative clustering on the undetermined clustering centers being the feature vectors of adjacent speech parts in the training corpus.

### Fifth Embodiment

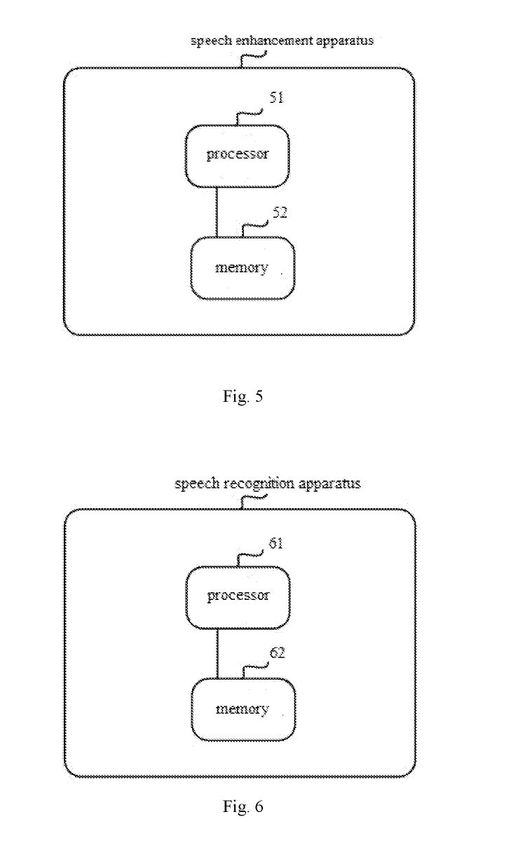

The fifth embodiment provides a speech enhancement apparatus for achieving a better speech enhancement effect. The structure diagram of the speech enhancement apparatus is as shown in FIG. 5, wherein the speech enhancement apparatus mainly comprising the following:

a processor 51; and

an memory 52 for storing commands executed by the processor 51;

wherein the processor 51 is configured to:

selecting a feature vector clustering center best matched with the feature vector of a first frame speech part contained in a test speech from feature vector clustering centers obtained by training; performing direct to the feature vectors of other frame speech parts contained in the test speech: selecting a feature vector clustering center best matched with the feature vector of the speech part from a feature vector clustering center best matched with the feature vector of a previous frame speech part to the speech part and obtained by training and a feature vector clustering center adjacent to the feature vector clustering center best matched with the feature vector of the previous frame speech part, wherein a set formed by each of the feature vector clustering centers obtained by training and at least one adjacent feature vector clustering center thereof has an ability to describe speech continuity; and reconstructing the feature vector of the test speech according to the feature vectors of each frame speech part contained in the test speech and the selected feature vector clustering center.

### Sixth Embodiment

The sixth embodiment provides a speech recognition apparatus. The structure diagram of the speech recognition apparatus is as shown in FIG. 6, wherein the speech recognition apparatus mainly comprising the following:

a processor 61; and

an memory 62 for storing commands executed by the processor 61;

wherein the processor 61 is configured to:

selecting a feature vector clustering center best matched with the feature vector of a first frame speech part contained in a test speech from feature vector clustering centers obtained by training; performing direct to the feature vectors of other frame speech parts contained in the test speech: selecting a feature vector clustering center best matched with the feature vector of the speech part from a feature vector clustering center best matched with the feature vector of a previous frame speech part to the speech part and obtained by training and a feature vector clustering center adjacent to the feature vector clustering center best matched with the feature vector of the previous frame speech part, wherein a set formed by each of the feature vector clustering centers obtained by training and at least one adjacent feature vector clustering center thereof has an ability to describe speech continuity; reconstructing the feature vector of the test speech according to the feature vectors of each frame speech part contained in the test speech and the selected feature vector clustering center; and performing speech recognition on the reconstructed feature vector of the test speech.

### Seventh Embodiment

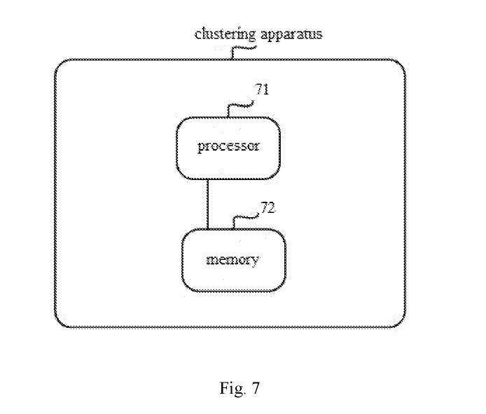

The seventh embodiment provides a clustering apparatus for respectively extracting and clustering feature vector samples from each frame speech part contained in a training corpus. The structure diagram of the clustering apparatus is as shown in FIG. 7, wherein the clustering apparatus mainly comprising the following:

a processor 71; and

an memory 72 for storing commands executed by the processor 71;

wherein the processor 71 is configured to:

respectively extracting feature vector samples from each frame speech part contained in a training corpus; determining the distribution information of the feature vector samples in a multidimensional space; determining initial clustering centers according to the distribution information; performing iterative clustering on each initial clustering center to obtain undetermined clustering centers according to the similarity between the feature vector samples and each initial clustering center; and performing iterative clustering on the undetermined clustering centers to obtain a feature vector clustering center according to given iterative clustering rules;

wherein, the given iterative clustering rules comprise: performing iterative clustering on the undetermined clustering centers according to the feature vectors of each speech part of the training corpus; the feature vector pursuant when performing single iterative clustering on the undetermined clustering centers being the feature vector of single speech part in the training corpus; and the feature vectors respectively pursuant when performing every two adjacent iterative clustering on the undetermined clustering centers being the feature vectors of adjacent speech parts in the training corpus.

It should be appreciated by those skilled in this art that the embodiments of the present invention can be provided as method, system or computer program product. Therefore, the embodiments of the present invention may be realized by complete hardware embodiments, complete software embodiments, or software-hardware combined embodiments. Moreover, the present invention may be realized in the form of a computer program product that is applied to one or more computer-usable storage mediums (including, but not limited to disk memory, CD-ROM or optical memory) in which computer-usable program codes are contained.

The embodiments of the methods and device described above are only exemplary, wherein the units illustrated as separation parts may either be or not physically separated, and the parts displayed by units may either be or not physical units, i.e., the parts may either be located in the same plate, or be distributed on a plurality of network units. A part or all of the modules may be selected according to an actual requirement to achieve the objectives of the solutions in the embodiments. Those having ordinary skills in the art may understand and implement without going through creative work.

Through the above description of the implementation manners, those skilled in the art may clearly understand that each implementation manner may be achieved in a manner of combining software and a necessary common hardware platform, and certainly may also be achieved by hardware. Based on such understanding, the foregoing technical solutions essentially, or the part contributing to the prior art may be implemented in the form of a software product. The computer software product may be stored in a storage medium such as a ROM/RAM, a magnetic disc, an optical disk or the like, and includes several instructions for instructing a computer device (which may be a personal computer, a server, or a network device so on) to execute the method according to each embodiment or some parts of the embodiments.

It should be finally noted that the above embodiments are only configured to explain the technical solutions of the present invention, but are not intended to limit the protection scope of the present invention. Although the present invention has been illustrated in detail according to the foregoing embodiments, those having ordinary skills in the art should understand that modifications can still be made to the technical solutions recited in various embodiments described above, or equivalent substitutions can still be made to a part of technical features thereof, and these modifications or substitutions will not make the essence of the corresponding technical solutions depart from the spirit and scope of the claims.

1. A speech enhancement method, comprising:
selecting a feature vector clustering center best matched with the feature vector of a first frame speech part contained in a test speech from feature vector clustering centers obtained by training by a selection unit;
performing direct to the feature vectors of other frame speech parts contained in the test speech: selecting a feature vector clustering center best matched with the feature vector of the speech part from a feature vector clustering center best matched with the feature vector of a previous frame speech part to the speech part and obtained by training and a feature vector clustering center adjacent to the feature vector clustering center best matched with the feature vector of the previous frame speech part, wherein a set formed by each of the feature vector clustering centers obtained by training and at least one adjacent feature vector clustering center thereof has an ability to describe speech continuity; and
reconstructing the feature vector of the test speech according to the feature vectors of each frame speech part contained in the test speech and the selected feature vector clustering center by a reconstruction unit; and
performing speech recognition on a the reconstructed feature vector of the test speech by a speech recognition.

2. The method according to claim 1, wherein reconstructing the feature vector of the test speech according to the feature vectors of each frame speech part contained in the test speech and the selected feature vector clustering center comprises:
performing an interpolation operation on a vector set formed by the feature vectors of all the speech parts contained in the test speech according to the selected feature vector clustering center, so as to obtain the reconstructed feature vector of the test speech.

3. The method according to claim 1, wherein the method, before selecting the feature vector clustering center best matched with the feature vector of the first frame speech part contained in the test speech from the feature vector clustering center obtained by training, further comprises:
respectively extracting feature vector samples from each frame speech part contained in a training corpus;
determining the distribution information of the feature vector samples in a multidimensional space;
determining initial clustering centers according to the distribution information;
performing iterative clustering on each initial clustering center to obtain undetermined clustering centers according to the similarity between the feature vector samples and each initial clustering center; and
performing iterative clustering on the undetermined clustering centers to obtain a feature vector clustering center according to given iterative clustering rules;
wherein, the given iterative clustering rules comprise: performing iterative clustering on the undetermined clustering centers according to the feature vectors of each speech part of the training corpus; the feature vector pursuant when performing single iterative clustering on the undetermined clustering centers being the feature vector of single speech part in the training corpus; and the feature vectors respectively pursuant when performing every two adjacent iterative clustering on the undetermined clustering centers being the feature vectors of adjacent speech parts in the training corpus.

4. The method according to claim 3, wherein performing iterative clustering on the undetermined clustering centers to obtain the feature vector clustering center according to the given iterative clustering rules comprises:
performing iterative clustering operation direct to each training corpus according to the given iterative clustering rules, and when an iterative convergence condition is satisfied, determining each undetermined clustering center having the parameter value calculated when the iterative convergence condition is satisfied as the feature vector clustering center, wherein the iterative clustering operation comprises the following steps:
determining the similarity between the feature vector of the first frame speech part of the training corpus and the undetermined clustering center best matched with the feature vector of the first frame speech part, and the similarity between the feature vector of the first frame speech part and the undetermined clustering center adjacent to the best matched undetermined clustering center;
performing direct to other frame speech parts of the training corpus: determining the undetermined clustering center best matched with the speech part, and determining the similarity between the feature vector of the speech part and the best matched undetermined clustering center and the similarity between the feature vector of the speech part and the undetermined clustering center adjacent to the best matched undetermined clustering center from the undetermined clustering center best matched with the feature vector of the previous frame speech part adjacent to the speech part and the clustering center adjacent to the undetermined clustering center best matched with the feature vector of the previous frame speech part adjacent to the speech part in the specific space; and
calculating the parameter values of each undetermined clustering center according to each similarity determined.

5.-12. (canceled)

13. An electrical apparatus, comprising:
a processor; and
an memory for storing commands executed by the processor;
wherein the processor is configured to:
selecting a feature vector clustering center best matched with the feature vector of a first frame speech part contained in a test speech from feature vector clustering centers obtained by training; performing direct to the feature vectors of other frame speech parts contained in the test speech: selecting a feature vector clustering center best matched with the feature vector of the speech part from a feature vector clustering center best matched with the feature vector of a previous frame speech part to the speech part and obtained by training and a feature vector clustering center adjacent to the feature vector clustering center best matched with the feature vector of the previous frame speech part, wherein a set formed by each of the feature vector clustering centers obtained by training and at least one adjacent feature vector clustering center thereof has an ability to describe speech continuity; reconstructing the feature vector of the test speech according to the feature vectors of each frame speech part contained in the test speech and the selected feature vector clustering center; and performing speech recognition on the reconstructed feature vector of the test speech.

14. (canceled)

15. The apparatus according to claim 13, wherein the processor is configured to:
performing an interpolation operation on a vector set formed by the feature vectors of all the speech parts contained in the test speech according to the selected feature vector clustering center, so as to obtain the reconstructed feature vector of the test speech.

16. The apparatus according to claim 13, wherein the processor is configured to:
respectively extracting feature vector samples from each frame speech part contained in a training corpus;
determining the distribution information of the feature vector samples in a multidimensional space;
determining initial clustering centers according to the distribution information;
performing iterative clustering on each initial clustering center to obtain undetermined clustering centers according to the similarity between the feature vector samples and each initial clustering center; and
performing iterative clustering on the undetermined clustering centers to obtain a feature vector clustering center according to given iterative clustering rules;
wherein, the given iterative clustering rules comprise: performing iterative clustering on the undetermined clustering centers according to the feature vectors of each speech part of the training corpus; the feature vector pursuant when performing single iterative clustering on the undetermined clustering centers being the feature vector of single speech part in the training corpus; and the feature vectors respectively pursuant when performing every two adjacent iterative clustering on the undetermined clustering centers being the feature vectors of adjacent speech parts in the training corpus.

17. The apparatus according to claim 13, wherein the processor is configured to:
performing iterative clustering operation direct to each training corpus according to the given iterative clustering rules, and when an iterative convergence condition is satisfied, determining each undetermined clustering center having the parameter value calculated when the iterative convergence condition is satisfied as the feature vector clustering center, wherein the iterative clustering operation comprises the following steps:
determining the similarity between the feature vector of the first frame speech part of the training corpus and the undetermined clustering center best matched with the feature vector of the first frame speech part, and the similarity between the feature vector of the first frame speech part and the undetermined clustering center adjacent to the best matched undetermined clustering center;
performing direct to other frame speech parts of the training corpus: determining the undetermined clustering center best matched with the speech part, and determining the similarity between the feature vector of the speech part and the best matched undetermined clustering center and the similarity between the feature vector of the speech part and the undetermined clustering center adjacent to the best matched undetermined clustering center from the undetermined clustering center best matched with the feature vector of the previous frame speech part adjacent to the speech part and the clustering center adjacent to the undetermined clustering center best matched with the feature vector of the previous frame speech part adjacent to the speech part in the specific space; and
calculating the parameter values of each undetermined clustering center according to each similarity determined.

18. A non-transitory computer storage media having computer-executable instructions stored thereon which, when executed by a computer, cause the computer to:
respectively extracting feature vector samples from each frame speech part contained in a training corpus; determining the distribution information of the feature vector samples in a multidimensional space; determining initial clustering centers according to the distribution information; performing iterative clustering on each initial clustering center to obtain undetermined clustering centers according to the similarity between the feature vector samples and each initial clustering center; and performing iterative clustering on the undetermined clustering centers to obtain a feature vector clustering center according to given iterative clustering rules;
wherein, the given iterative clustering rules comprise: performing iterative clustering on the undetermined clustering centers according to the feature vectors of each speech part of the training corpus; the feature vector pursuant when performing single iterative clustering on the undetermined clustering centers being the feature vector of single speech part in the training corpus; and the feature vectors respectively pursuant when performing every two adjacent iterative clustering on the undetermined clustering centers being the feature vectors of adjacent speech parts in the training corpus.
